(19) United States
(12) Patent Application Publication
(10) Pub. No.: US 2026/0208511 A1
(43) Pub. Date: Jul. 23, 2026

(54) PERSONALIZED CARD PRINTING USING A HIGH RESOLUTION PRINTHEAD

(71) Applicant: Entrust Corporation, Shakopee, MN (US)

(72) Inventors: Ethan YANNA, Shakopee, MN (US); John KNAACK, Shakopee, MN (US); Matt WOLD, Shakopee, MN (US); Nameeta KRENZ, Shakopee, MN (US); John MILLER, Shakopee, MN (US)

(21) Appl. No.: 19/453,640

(22) Filed: Jan. 20, 2026

Related U.S. Application Data
(60) Provisional application No. 63/747,732, filed on Jan. 21, 2025.

(51) Int. Cl. B41J 13/00; B41J 2/325; B41J 3/407; B41J 31/00; B41J 35/16; B41M 3/00; B42D 25/20

(52) U.S. Cl. CPC B41J 13/0027; B41J 2/325; B41J 3/407; B41J 31/00; B41J 35/16; B41M 3/005; B42D 25/20

(57) ABSTRACT

A personalized card printer includes a card printing station with a thermal printhead that has a first resolution, and the card printing station is controlled so that the resulting printing on the personalized card by the thermal printhead has a resolution that is lower than the first resolution. The lower resolution printing may be achieved by controlling the transport speed to increase the transport speed past the printhead. The transport speed is increased compared to what the transport speed past the printhead would be to print at the first, higher resolution of the thermal printhead.

### PRIORITY

This application claims the benefit of priority to U.S. Application No. 63/747,732, filed on Jan. 21, 2025, the entire contents of which are incorporated herein by reference.

### FIELD

This technical disclosure relates to printing on personalized cards such as financial cards including credit and debit cards, identification cards, driver's licenses, and other cards that are personalized, as well as passport pages.

### BACKGROUND

When printing on personalized cards and passport pages using a high-resolution thermal printhead and a thermal print ribbon, some printing may not require a high-resolution and can be printed at a lower resolution. An example of printing on a personalized card at a resolution that is lower than the maximum resolution of the printhead is described in U.S. Pat. No. 10,814,657, the entire contents of which are incorporated herein by reference.

### SUMMARY

Personalized card printers and methods of operating personalized card printers to print personalized cards (as well as passport pages) are described. The personalized cards can be financial cards including credit and debit cards, identification cards, driver's licenses, and other cards that are personalized.

The personalized card printers include a card printing station that includes a thermal printhead that has a first resolution, and a thermal print ribbon having transferrable colorant material that is transferrable to a personalized card by the thermal printhead. The card printing station is controlled so that some or all of the resulting printing on the personalized card has a resolution that is lower than the first resolution. The card printing station can be configured as a direct-to-card card printing station where the printing occurs directly on the personalized card, or the card printing station can be configured as a re-transfer card printing station where the printing initially occurs on an intermediate transfer film and thereafter a transferrable material of the intermediate transfer film bearing the printing is transferred to the personalized card.

The lower resolution printing described herein helps increase the card throughput of the card printing station and the personalized card printer since the input images can be smaller thereby taking less time to process into printhead data and requiring less data to be sent to the printhead. In addition, in the case of a thermal print ribbon with panels of transferrable colorant material to print a multi-color image, the larger pixel sizes are easier to print accurately and easier to align each subsequently printed color panel with a previously printed color panel to print the multi-color image.

In an embodiment, the transport may be controlled to increase the transport speed of the personalized card or the intermediate transfer film past the printhead. The transport speed may be increased compared to what the transport speed of the personalized card or the intermediate transfer film past the printhead would be to print at the rated resolution of the thermal printhead. This results in what can be referred to as a movement resolution (e.g. a card movement resolution when printing directly onto the card or an intermediate transfer film movement resolution in the case of printing on the intermediate transfer film) in the transport direction that is less than the resolution of the thermal printhead, with the printing occurring at the movement resolution rather than at the rated resolution. Increasing the transport speed also results in faster printing by the card printing station and increases the card throughput. The movement resolution may also be referred to as a transport resolution.

In an embodiment, increasing the transport speed of the personalized card or the intermediate transfer film past the printhead results in the printing of non-square pixels in the transport direction that form the printing on the personalized card or the intermediate transfer film. In an embodiment, the printed pixels may have a quadrilateral shape. In an embodiment, the printed pixels may be rectangular in shape. However, other pixel shapes are possible. In an embodiment, some of the printed pixels of the printing may have a non-square shape and other printed pixels of the printing may have a square shape.

With the transport direction defining a width direction of the pixel and the transverse direction (or the length direction of the printhead) defining a height of the pixel, at least some of or all the pixels may have a pixel aspect ratio (PAR) which is the pixel width divided by the pixel height that is greater than 1.0. In an embodiment, at least some of or all the pixels may have a PAR of 2.0 or substantially 2.0 or approximately 2.0. In another embodiment, at least some of or all the pixels may have a PAR of between about 2.0 and 3.0, or a PAR of between about 2.0 and 2.75, or a PAR of between about 2.0 and 2.5, or a PAR of between about 2.0 and 2.25, or a PAR of greater than 1.0 but less than or equal to about 2.0. In an embodiment, some of the pixels may have a PAR greater than 1.0 and some of the pixels may have a PAR of 1.0.

In an embodiment, the card printing station may be controlled to print at a high-resolution setting (i.e., at the rated resolution of the high resolution printhead) and at a lower resolution setting (i.e., at a resolution lower than the rated resolution of the high resolution printhead). The high-resolution setting and the lower resolution setting may be applicable in different print jobs on different personalized cards. In an embodiment, the high-resolution setting and the lower resolution setting may be implemented in the same print job on the same personalized card. In an embodiment, the high-resolution setting and the lower resolution setting may be user selectable via a suitable user input into the personalized card printer in real-time prior to printing on the personalized card. In another embodiment, the high-resolution setting and the lower resolution setting may be automatically selected by the personalized card printer, for example based on data included in print job data provided to the personalized card printer that determines the data to be printed onto the personalized card.

The thermal print ribbon may be a multi-color print ribbon with discrete, differently colored, repeating panels of transferrable colorant material. The thermal print ribbon may also be a monochromatic print ribbon with a single color, transferrable colorant material.

In an embodiment, a personalized card printer that prints a personalized card can comprise a card printing station that includes a thermal printhead that has a first resolution, and a thermal print ribbon having transferrable colorant material that is transferrable to the personalized card (or to an intermediate transfer film) by the thermal printhead. The card printer can further include a card transport (or intermediate transfer film transport) that is configured to transport the personalized card (or the intermediate transfer film) in the card printing station in a card (or intermediate transfer film) transport direction past the thermal printhead to transfer colorant material from the thermal print ribbon using the thermal printhead to form printed data on the personalized card (or on the intermediate transfer film), where the printed data includes a plurality of pixels. A controller may be connected to the card transport to control the operation thereof. The controller may be configured to control the card transport to transport the personalized card (or the intermediate transfer film) past the thermal printhead at a first card transport speed (or first intermediate transfer film transport speed) and the transport speed has a corresponding movement resolution that is less than the first resolution.

In an embodiment, at least some of the pixels may have a non-square shape in the transport direction. The non-square shape may be a non-square quadrilateral such as a rectangle.

At least some of the pixels may have a PAR greater than 1.0 in the transport direction. The PAR may be 2.0, or between greater than 1.0 but less than or equal to 2.0, or between greater than 1.0 but less than or equal to 2.5, or between greater than 1.0 but less than or equal to 3.0.

In another embodiment, a personalized card printer that prints a personalized card may comprise a card printing station that includes a thermal printhead that has a first resolution, and a thermal print ribbon having transferrable colorant material that is transferrable to the personalized card or to an intermediate transfer film by the thermal printhead. A transport may be configured to transport the personalized card or the intermediate transfer film in the card printing station past the thermal printhead to transfer colorant material from the thermal print ribbon using the thermal printhead to form printed data on the personalized card or on the intermediate transfer film. A controller may be connected to the transport to control the operation thereof. The controller may be configured to control the transport to transport the personalized card or the intermediate transfer film past the thermal printhead at a transport speed that has a corresponding movement resolution that is less than the first resolution.

The corresponding movement resolution that is less than the first resolution results in the printed pixels having a non-square shape in a transport direction. The non-square shape may be a non-square quadrilateral such as a rectangle. Further, at least some of the pixels may have a PAR greater than 1.0 in the transport direction.

In another embodiment, a method of operating a personalized card printer to print a personalized card can comprise inputting the personalized card and transporting the personalized card to a card printing station that includes a thermal printhead that has a first resolution, and a thermal print ribbon having transferrable colorant material that is transferrable to the personalized card (or to an intermediate transfer film) by the thermal printhead. The personalized card (or the intermediate transfer film) is transported in the card printing station past the thermal printhead, and colorant material is transferred from the thermal print ribbon using the thermal printhead to form printed data on the personalized card (or on the intermediate transfer film). Transporting the personalized card (or the intermediate transfer film) in the card printing station can comprise transporting the personalized card (or the intermediate transfer film) past the thermal printhead at a transport speed that has a corresponding movement resolution that is less than the first resolution.

In another embodiment, a method of operating a personalized card printer to print a personalized card can comprise inputting the personalized card and transporting the personalized card to a card printing station that includes a thermal printhead that has a first resolution, and a thermal print ribbon having transferrable colorant material that is transferrable to the personalized card or to an intermediate transfer film by the thermal printhead. The personalized card or the intermediate transfer film may be transported in the card printing station in a transport direction past the thermal printhead at a transport speed and colorant material is transferred from the thermal print ribbon using the thermal printhead to form printed data on the personalized card or on the intermediate transfer film. The transport speed has a corresponding movement resolution that is less than the first resolution.

### DRAWINGS

FIG. 1 depicts a method of operating a personalized card printer to print a personalized card as described herein.

FIGS. 2A and 2B depict front and rear side surfaces, respectively, of a personalized card as described herein.

FIG. 3 depicts an example of non-square pixels described herein.

FIG. 4 depicts another example of non-square pixels described herein.

FIG. 5 depicts an example of non-square pixels and square pixels in the printed data.

FIG. 6 schematically depicts a personalized card printer described herein.

FIG. 7 schematically depicts a portion of a direct-to-card card printing station described herein.

FIG. 8 schematically depicts a portion of a multi-color thermal print ribbon with panels of transferrable colorant material.

FIG. 9 schematically depicts a portion of a re-transfer card printing station described herein.

### DETAILED DESCRIPTION

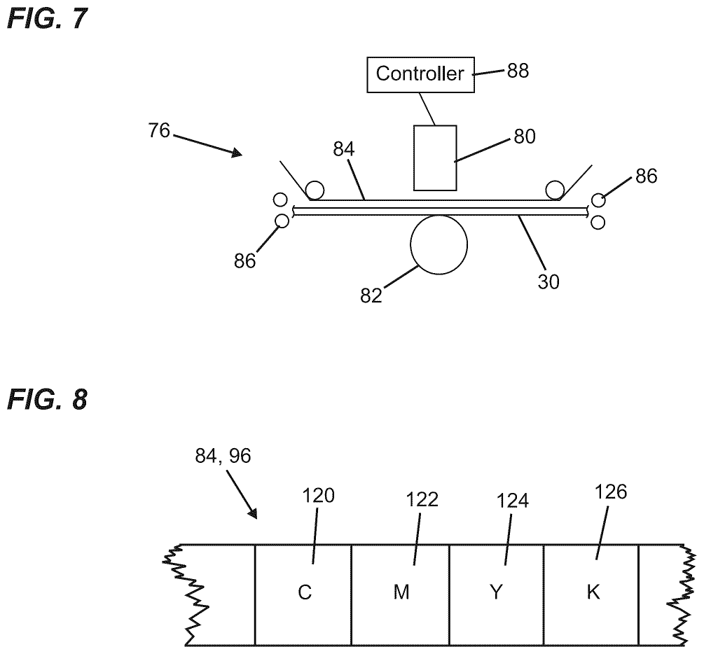

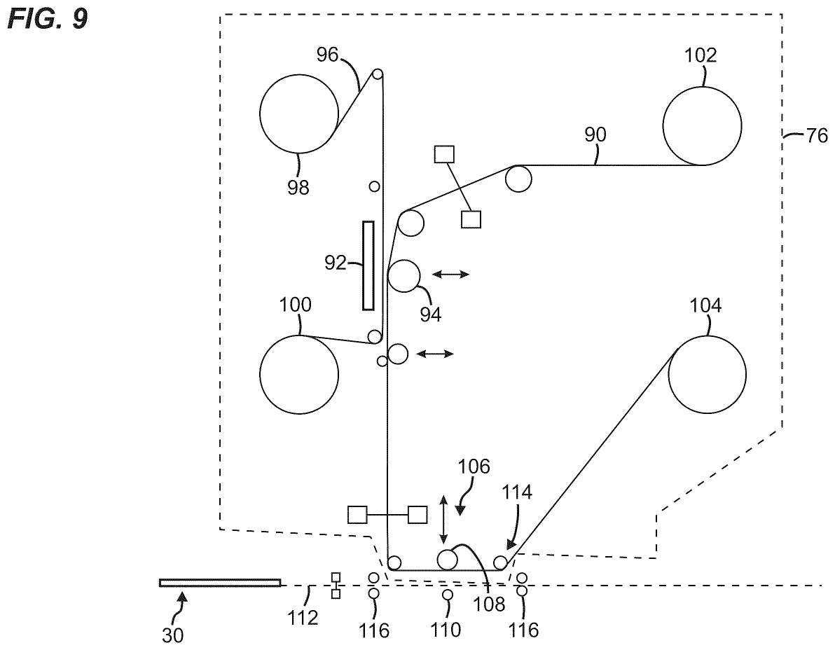

The following is a description of personalized card printers and methods of operating personalized card printers to print personalized cards (as well as passport pages). The personalized card printer includes a thermal printhead that has a first resolution, and the card printing station is controlled so that some or all of the resulting printing on the personalized card by the thermal printhead has a resolution that is lower than the first resolution. The card printing station can be configured as a direct-to-card card printing station (described below with respect to FIG. 7) where the printing occurs directly on the personalized card, or the card printing station can be configured as a re-transfer card printing station (described below with respect to FIG. 9) where the printing initially occurs on an intermediate transfer film and thereafter a transferrable material of the intermediate transfer film bearing the printing is transferred to the personalized card.

In an embodiment, the lower resolution printing is achieved by controlling the transport speed to increase the transport speed of the personalized card or the intermediate transfer film past the printhead. The transport speed may be increased compared to what the transport speed of the personalized card or the intermediate transfer film past the printhead would be to print at the rated, higher resolution of the thermal printhead. This results in what can be referred to as a movement resolution (e.g. a card movement resolution when printing directly onto the card or an intermediate transfer film movement resolution in the case of printing on the intermediate transfer film) in the transport direction that is less than the resolution of the thermal printhead, with the printing occurring at the movement resolution rather than at the rated resolution. Increasing the transport speed also results in faster printing by the card printing station and increases the card throughput. In addition, the lower resolution printing described herein further helps increase the card throughput of the card printing station and the personalized card printer since the input images can be smaller thereby taking less time to process into printhead data and requiring less data to be sent to the printhead. In addition, in the case of a thermal print ribbon with panels of transferrable colorant material, the larger pixel sizes are easier to print accurately and easier to align to other previously printed panels.

The personalized card can be a financial card including a credit or debit card, identification card, driver's license, and other cards that are personalized. The card can be a card which may be made entirely of plastic, or a combination of plastic and non-plastic materials. In an embodiment, the card may be made partially or entirely of non-plastic materials such as paper or metal. In an embodiment, the card may be made of a plastic such as polycarbonate, polyvinyl chloride (PVC), polyethylene terephthalate glycol (PETG), and other plastics. In an embodiment, the card may be an ID-1 card as defined by ISO/IEC 7810. However, other card formats such as ID-2 as defined by ISO/IEC 7810 are possible as well. In an embodiment, the techniques described herein can be used on other identification document substrates such as passports like a front cover page or a rear cover page of the passport, or an internal page (for example a plastic page referred to as a data page) of the passport. In an embodiment, the passports may be in an ID-3 format as defined by ISO/IEC 7810.

The term “personalized” (or the like) as used throughout the specification and claims, unless indicated otherwise, is intended to encompass operations performed on a card (or passport) that includes operations that result in personalizing the card as well as operations that do not result in personalizing the card. An example of a personalization operation that personalizes the card is printing the intended card holder's image or name on the card. An example of a personalization operation that does not personalize the card is printing non-card holder graphics on the card. The term “personalize” is often used in the personalized card industry to refer to a card or other identification document that undergoes both personalization processing operations and non-personalization processing operations. In addition, the term “personalized card” as used throughout the specification and claims, unless indicated otherwise, is intended to encompass a card (or passport page) prior to any actual personalization being applied to the card as well as to the card after having personalization applied thereto.

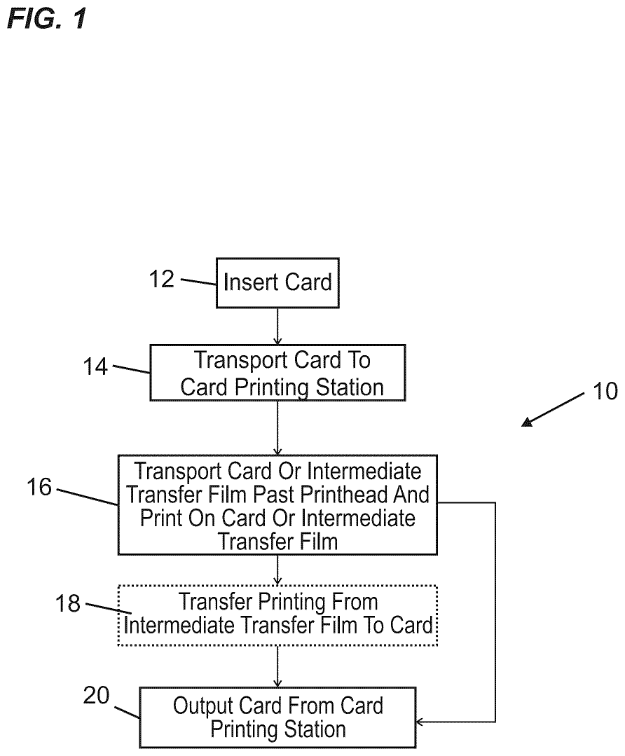

Referring initially to FIG. 1, an example of a method 10 of operating a personalized card printer to print a personalized card is illustrated. The word “step” should be construed, unless otherwise indicated by Applicant, as including a single step or multiple sub-steps resulting in the step. In the method 10, a card to be printed on is inserted at step 12 and the card is transported at step 14 to a card printing station of the personalized card printer. The card may be immediately transported to the card printing station after being input, or one or more card processing operations may take place on the card prior to being transported to the card printing station. The card printing station may be configured as a direct-to-card card printing station (FIG. 7) where the printing occurs directly on the personalized card, or the card printing station may be configured as a re-transfer card printing station (FIG. 9) where the printing initially occurs on an intermediate transfer film and thereafter a transferrable material of the intermediate transfer film bearing the printing is transferred to the card. In either case, the card printing station includes a thermal printhead and a thermal print ribbon having transferrable colorant material that is transferrable by the thermal printhead.

At step 16, the card or the intermediate transfer film is transported at least once past the thermal printhead, and the card or intermediate transfer film is printed on. In an embodiment, for example in the case of multi-color printing using a single printhead, the card or the intermediate transfer film may be transported multiple times past the thermal printhead, and the card or intermediate transfer film is printed on during each pass past the printhead. In the case of re-transfer printing on the intermediate transfer film, optional step 18 can take place where the printing on the intermediate transfer film is transferred to the card, and the now printed card can then be output from the card printing station at step 20. In the case of direct-to-card printing in step 16, the method 10 can skip to step 20 and now printed card can then be output from the card printing station at step 20. After being output from the card printing station, the printed card may undergo additional card processing (examples are described further below), or the card may be output from the personalized card printer without any further processing.

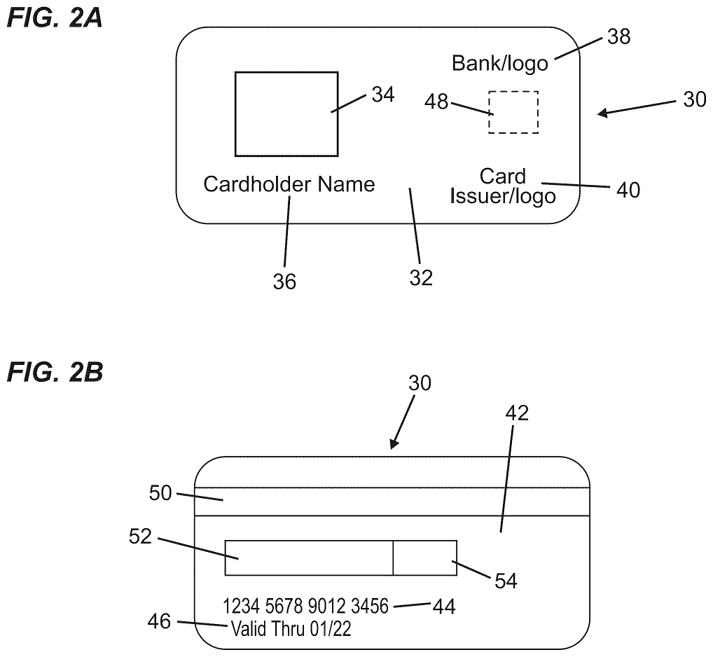

FIGS. 2A and 2B depict an example of a personalized card 30 described herein. FIG. 2A depicts an example of a front surface 32 of the card 30 where the front surface 32 can include printed data, or just printing, such as a printed image 34 of the intended cardholder, the printed name 36 of the intended cardholder, and other printing such as a printed bank logo 38 or a printed card issuer logo 40. FIG. 2B depicts an example of a rear surface 42 of the card 30 where the rear surface 40 can include printed data, or just printing, such as an account number 44, an expiration date 46, and other printing. The card 30 may also include a programmable chip 48 embedded therein which may be accessible via the front surface 32, a magnetic strip 50, a signature panel 52, and a panel 54 for a card verification value (CVV) number.

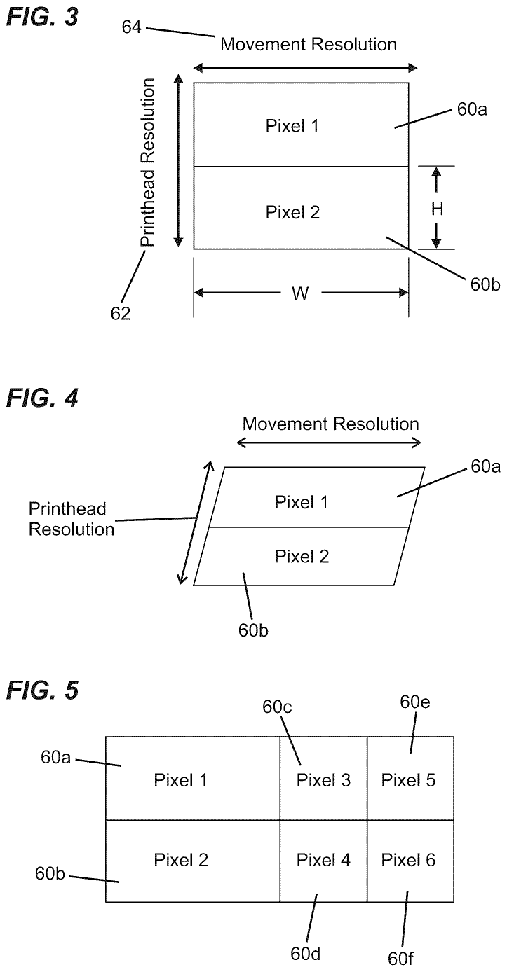

Referring to FIG. 1 together with FIG. 3, the thermal printhead of the card printing station has a printhead resolution (also referred to as a first resolution or a rated resolution). In step 16, at least some of the printing (or all of the printing in step 16) takes place at a resolution that is lower than the printhead resolution. The lower resolution printing may be achieved by controlling the transport speed to increase the transport speed of the personalized card or the intermediate transfer film past the printhead. The transport speed is increased compared to what the transport speed of the personalized card or the intermediate transfer film past the printhead would be to print at the printhead resolution (i.e., the rated, higher resolution of the thermal printhead). This results in what can be referred to as a movement resolution (e.g. a card movement resolution when printing directly onto the card or an intermediate transfer film movement resolution in the case of printing on the intermediate transfer film) in the transport direction that is less than the printhead resolution, with the printing occurring at the movement resolution rather than at the rated resolution. The movement resolution may also be referred to as a transport resolution. In an embodiment, the printhead resolution may be 600 dots per inch (DPI) while the movement resolution may be 300 DPI. However, other printhead resolutions and other movement resolutions may be used as long as, for at least some of the pixels, the movement resolution is less than the printhead resolution.

FIG. 3 depicts an example of two of the pixels 60a, 60b of the printing that results from step 16. The printhead resolution 62 is depicted along or parallel to the length of the thermal printhead. The movement resolution 64 is depicted along or parallel to the transport direction (i.e. the card transport direction or the intermediate transfer film transport direction) past the thermal printhead. By increasing the transport speed, the pixels 60a, 60b have a non-square shape in the transport direction. For example, the pixels 60a, 60b are depicted as having a rectangular shape. Each pixel has a width W in the transport direction and a height H in a direction parallel to the printhead or transverse to the width W. Each pixel therefore has a PAR of W/H. In an embodiment, each non-square shaped pixel has a PAR greater than 1.0. In an embodiment, the PAR may be 2.0, or about 2.0, or approximately 2.0, or substantially 2.0.

The pixels 60a, 60b can have non-square shapes other than rectangular. For example, FIG. 4 depicts the pixels 60a, 60b as having a rhomboid shape. The rhomboid shape in FIG. 4 may result from the thermal printhead being disposed at an acute angle to the transport direction, and with the increased transport speed described above.

The printing may also performed so that some of the printing occurs at a movement

resolution that is less than the printhead resolution and some of the printing occurs at a movement resolution that equal to the printhead resolution. This results in a combination of non-square pixels and square pixels. For example, referring to FIG. 5, a portion of the printing is depicted as including the non-square pixels 60a, 60b (i.e. the movement resolution is less than the printhead resolution) as well as square pixels 60c, 60d, 60e, 60f (i.e. the movement resolution equals the printhead resolution). The square pixels 60c-f result from reducing the transport speed compared to the transport speed used to print the pixels 60a, 60b. With the square pixels 60c-f, the movement resolution is equal to (or about equal to, or approximately equal to, or substantially equal to) the printhead resolution.

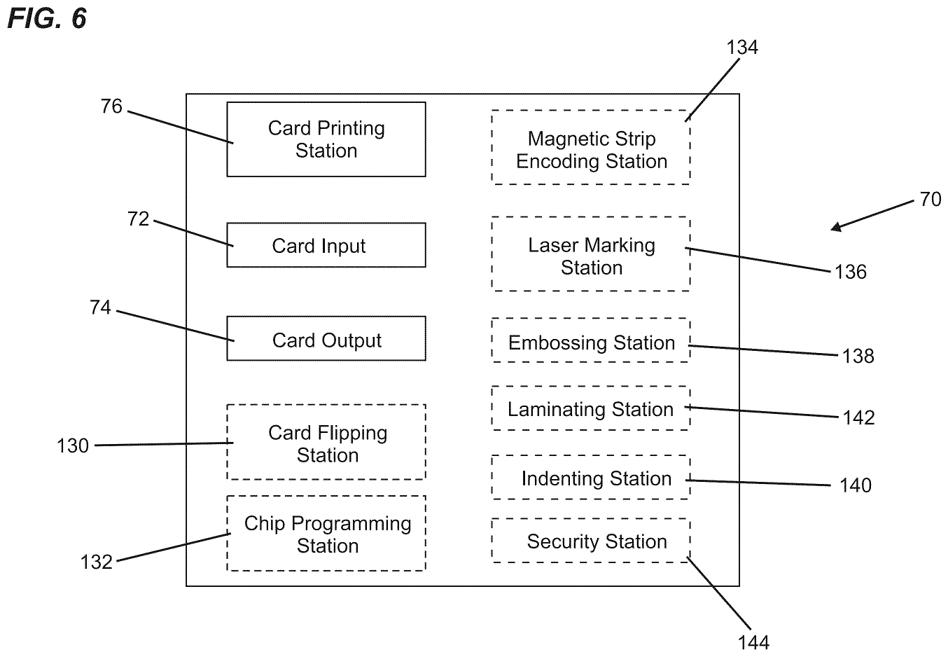

FIG. 6 schematically depicts an example of a personalized card printer 70 that can implement the techniques described herein. The printer 70 includes a card input 72, a card output 74, and a card printing station 76.

The card input 72 can be an input hopper designed to hold a plurality of cards waiting to be fed on-by-one into the printer 70 for printing. An example of an input hopper is described in U.S. Pat. No. 6,902,107 which is incorporated herein by reference in its entirety. Alternatively, the card input 72 can be an input slot through which individual cards are fed one-by-one into the printer 70.

The card output 74 can be a card output hopper designed to hold a plurality of printed cards that are output one-by-one after being printed within the printer 70. An example of a card output hopper is described in U.S. Pat. No. 6,902,107 which is incorporated herein by reference in its entirety. Alternatively, the card output 74 can be an output slot through which individual cards are output one-by-one. The card output 74 can be the last element in the card printer 70 and located at the downstream end of the card printer 70. However, the card output 74 is not required in a central issuance card system and the processed cards can be output directly to an inserter mechanism that attaches the cards to card carrier forms to create card/carrier combinations, folds the card/carrier combinations and inserts the card carrier combinations into envelopes for mailing to the intended recipients. In the case of desktop card printer, the card output 74 can be located at the downstream end of the printer 70 in some printers, or even located at the same end of the printer 70 as the card input 72.

Referring to FIG. 7, in one embodiment the card printing station 76 may be configured as a direct-to-card thermal card printing station where the printing occurs directly on the personalized card. The general construction and operation of direct-to-card thermal card printing stations is known in the art.

In the example illustrated in FIG. 7, the card printing station 76 is depicted as including a thermal printhead 80 and a backing roller 82 positioned opposite the thermal printhead 80. The thermal printhead 80 can be of conventional construction. A thermal print ribbon 84 is supplied from a print ribbon supply (not shown) with used print ribbon being wound up on a print ribbon take-up (not shown). The thermal print ribbon 84 may be a multi-color print ribbon or a single color, monochromatic ribbon. The card 30 is transported into position and past the printhead 80 using suitable transport mechanisms known in the art. FIG. 7 depicts the transport mechanism as being transport rollers 86. A controller 88 is connected to the printhead 80 and to the transport mechanism to control the operation thereof, including controlling the transport speed of the card 30 during printing to result in the non-square pixels described above.

Referring to FIG. 9, in another embodiment, the card printing station 76 may be configured as a re-transfer card printing station (FIG. 9) where the printing initially occurs on an intermediate transfer film 90 and thereafter a transferrable material of the intermediate transfer film 90 bearing the printing is transferred to the card 30. The general construction and operation of re-transfer card printing stations is known in the art. In the example illustrated in FIG. 9, the card printing station 76 is depicted as including a thermal printhead 92 and a backing roller 94 positioned opposite the thermal printhead 92. The thermal printhead 92 can be of conventional construction. A thermal print ribbon 96 is supplied from a print ribbon supply 98 with used print ribbon being wound up on a print ribbon take-up 100. The thermal print ribbon 96 may be a multi-color print ribbon or a single color, monochromatic ribbon. The intermediate transfer film 90 is supplied from a film supply 102 on a retransfer side, and after retransfer the remaining film 90 is eventually wound onto a film take-up 104 also on the retransfer side. The intermediate transfer film 90 is directed past the backing roller 94 positioned opposite the printhead 92 and which in the illustrated example can be moved toward and away from the printhead 92 to press the intermediate transfer film 90 and the print ribbon 94 between the printhead 92 and the backing roller 94 during printing onto the intermediate transfer film 90.

With continued reference to FIG. 9, once the desired printing onto the intermediate transfer film 90 is complete, the section of the film 90 with the printing thereon is advanced to a transfer station 106 where transferrable material on the film 90 bearing the printing is transferred onto a surface of the card 30. In this example, the transfer station 106 includes a heated transfer mechanism 108, for example a transfer roller, which is movable toward and away from a fixed platen 110 positioned on the opposite side of a card travel or transport path 112 depicted by a dashed line. The heated transfer mechanism 108 presses the portion of the film 90 containing the printing against the surface of the card 30 which is backed by the platen 110, with the film 90 and the card 30 then being transported together past the heated transfer mechanism 108 to laminate the transferrable portion of the film 90 containing the printing onto the card 30. The film 90 and the card 30 are then transported to a stripping station 114 that includes a stripping pin or the like where the transferrable portion of the film 90 is stripped from the card 30 leaving behind the transferrable layer containing the printing on the card surface. Ultimately, the film 90, minus the transferred portion with the printing, is wound onto the film take-up 104. The card 30 is transported along the card travel path 112 by a card transport mechanism, such as sets of rollers 116.

Referring to FIG. 8, in an embodiment, the thermal print ribbon 84, 96 may be a multi-color thermal print ribbon that includes a plurality of panels of colorant material such as cyan (C) 120, magenta (M) 122, yellow (Y) 124 and black (K) 126 (i.e. a CMYK ribbon) that repeat in that sequence along the entire ribbon 84, 96. In some embodiments, other panels can also be present such as topcoat panels and/or UV panels. The CMY panels 120, 122, 124 may be used to generate multi-color printing on the card or on the intermediate transfer film. The K panels 126 may be used to print alphanumeric text on the card or on the intermediate transfer film.

The card printing station may be controlled to print at a high-resolution setting (i.e., at the rated resolution of the high resolution printhead) and at the lower, movement resolution setting (i.e., at a resolution lower than the rated resolution of the high resolution printhead). The high-resolution setting and the lower resolution setting may be applicable in different print jobs on different personalized cards. For example, one card may be printed at the high-resolution setting and another card in sequence therewith (either before or after the one card) may be printed at the lower, movement resolution. In an embodiment, the high-resolution setting and the lower resolution setting may be implemented in the same print job on the same personalized card. For example, some of the printing on the personalized card may occur at the high-resolution setting and other of the printing on the same personalized card may occur at the lower resolution setting. In an embodiment, the high-resolution setting and the lower resolution setting may be user selectable via a suitable user input into the personalized card printer in real-time prior to printing on the personalized card. In another embodiment, the high-resolution setting and the lower resolution setting may be automatically selected by the personalized card printer, for example based on data included in print job data provided to the personalized card printer that determines the data to be printed onto the personalized card.

Returning to FIG. 6, the personalized card printer 70 may optionally include one or more additional stations in addition to the card printing station 76. The printer 70 may include any combination of the following stations in addition to the card printing station 76.

For example, if printing on both sides of the card 30 is required, a card flipping station 130 (or card reorienting mechanism 130) can be provided in the printer 70. The card flipping station 130 can receive the card 30, for example after printing on one surface of the card, and flip the card over (i.e. flip the card 180 degrees) so that the opposite surface is now facing in a direction for printing on the opposite surface. In embodiments where printing on both surfaces is not required, the card flipping station 130 is not required, or the card can be transported through the card flipping station 130 without flipping the card.

In another embodiment, a chip programming station 132 and/or a magnetic strip encoding station 134 can be provided in the printer 70. The chip programming station 132, if present, is configured to program the chip 48 on the card 30 (see FIG. 2A). The station 132, if present, may be configured to program a single chip of a single card, or the station 132 may be configured to simultaneously program the chips on multiple cards. The magnetic strip encoding station 134, if present, is configured to magnetically read data from and/or magnetically data onto the magnetic strip 50 on the card 30 (see FIG. 2B).

In another embodiment, a laser marking station 136 can be provided in the printer 70. The laser marking station 136, if present, includes a laser that is used to create one or more markings on the card.

In another embodiment, an embossing station 138 and/or an indenting station 140 can be provided in the printer 70. The embossing station 138, if present, is configured to create one or more embossed characters on the card. The indenting station 140, if present, is configured to create one or more indented characters on the card.

In another embodiment, a laminating station 142 can be provided in the printer 70. The laminating station 142, if present, is configured to apply a laminate to the card.

In another embodiment, a security station 144 can be provided in the printer 70. The security station 144, if present, is configured to apply a security feature, such as a holographic foil patch, to the card.

The personalized card printer described herein may be configured as what is referred to as a desktop card personalization system that is typically designed for relatively small scale, individual card processing. In desktop card personalization systems, a single card to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Corporation of Shakopee, Minnesota. Other examples of desktop card personalization systems are disclosed in U.S. Pat. Nos. 7,434,728 and 7,398,972, each of which is incorporated herein by reference in its entirety.

In addition, the personalized card printer described herein may be configured as what is referred to as a central issuance card personalization system that is typically designed for large volume batch processing of cards, often employing multiple processing stations or modules to process multiple cards at the same time to reduce the overall per card processing time. Examples of central issuance card personalization systems include the MX family of central issuance systems available from Entrust Corporation of Shakopee, Minnesota. Other examples of central issuance systems are disclosed in U.S. Pat. Nos. 4,825,054, 5,266,781, 6,783,067, and 6,902,107, all of which are incorporated herein by reference in their entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A personalized card printer that prints a personalized card, comprising:
a card printing station that includes a thermal printhead that has a first resolution, and a thermal print ribbon having transferrable colorant material that is transferrable to the personalized card by the thermal printhead;
a card transport that is configured to transport the personalized card in the card printing station in a card transport direction past the thermal printhead to transfer colorant material from the thermal print ribbon using the thermal printhead to form printed data on the personalized card, the printed data includes a plurality of pixels;
a controller connected to the card transport and controlling the operation thereof, the controller is configured to control the card transport to transport the personalized card past the thermal printhead at a first card transport speed, and the first card transport speed has a corresponding movement resolution that is less than the first resolution.

2. The personalized card printer of claim 1, wherein at least some of the pixels have a pixel aspect ratio greater than 1.0 in the card transport direction.

3. The personalized card printer of claim 1, wherein the thermal print ribbon comprises a multi-color print ribbon with panels of the transferrable colorant material.

4. The personalized card printer of claim 1, wherein the controller is configured to control the card transport to transport the personalized card past the thermal printhead at a second card transport speed that results in at least some of the pixels of the printed data having a pixel aspect ratio of 1.0.

5. A personalized card printer that prints a personalized card, comprising:
a card printing station that includes a thermal printhead that has a first resolution, and a thermal print ribbon having transferrable colorant material that is transferrable to the personalized card or to an intermediate transfer film by the thermal printhead;
a transport that is configured to transport the personalized card or the intermediate transfer film in the card printing station past the thermal printhead to transfer colorant material from the thermal print ribbon using the thermal printhead to form printed data on the personalized card or the intermediate transfer film;
a controller connected to the transport and controlling the operation thereof, the controller is configured to control the transport to transport the personalized card or the intermediate transfer film past the thermal printhead at a transport speed that has a corresponding movement resolution that is less than the first resolution.

6. The personalized card printer of claim 5, wherein the printed data includes pixels that have a pixel aspect ratio greater than 1.0 in a transport direction.

7. The personalized card printer of claim 5, wherein the thermal print ribbon comprises a multi-color print ribbon with panels of the transferrable colorant material.

8. The personalized card printer of claim 5, wherein the controller is further configured to control the transport to transport the personalized card or the intermediate transfer film past the thermal printhead at a transport speed that has a corresponding movement resolution that is equal to the first resolution.

9. The personalized card printer of claim 5, wherein the card printing station further comprises a transfer station that is configured to transfer the printed data on the intermediate transfer film to a surface of the personalized card.

10. A method of operating a personalized card printer to print a personalized card, comprising:
inputting the personalized card and transporting the personalized card to a card printing station that includes a thermal printhead that has a first resolution, and a thermal print ribbon having transferrable colorant material that is transferrable to the personalized card by the thermal printhead; and
transporting the personalized card in the card printing station in a card transport direction past the thermal printhead at a card transport speed and transferring colorant material from the thermal print ribbon using the thermal printhead to form printed data on the personalized card, the printed data includes a plurality of pixels, and the card transport speed has a corresponding movement resolution that is less than the first resolution.

11. The method of claim 10, wherein at least some of the pixels have a pixel aspect ratio greater than 1.0 in the card transport direction.

12. The method of claim 10, wherein some of the pixels have a pixel aspect ratio of 1.0.

13. The method of claim 10, wherein the thermal print ribbon comprises a multi-color print ribbon with panels of the transferrable colorant material.

14. A method of operating a personalized card printer to print a personalized card, comprising:
inputting the personalized card and transporting the personalized card to a card printing station that includes a thermal printhead that has a first resolution, and a thermal print ribbon having transferrable colorant material that is transferrable to the personalized card or to an intermediate transfer film by the thermal printhead;
transporting the personalized card or the intermediate transfer film in the card printing station past the thermal printhead and transferring colorant material from the thermal print ribbon using the thermal printhead to form printed data on the personalized card or the intermediate transfer film;
wherein transporting the personalized card or the intermediate transfer film in the card printing station comprises transporting the personalized card or the intermediate transfer film past the thermal printhead at a transport speed that has a corresponding movement resolution that is less than the first resolution.

15. The method of claim 14, comprising transporting the personalized card or the intermediate transfer film past the thermal printhead to achieve a pixel aspect ratio greater than 1.0 in a transport direction.

16. The method of claim 14, wherein the thermal print ribbon comprises a multi-color print ribbon with panels of the transferrable colorant material.

17. The method of claim 14, further comprising transferring the printed data on the intermediate transfer film to a surface of the personalized card.
